(19) United States
(12) Patent Application Publication
(10) Pub. No.: US 2022/0215502 A1
(43) Pub. Date: Jul. 7, 2022

(54) SYSTEM AND METHOD FOR PROVIDING A DECISION BASIS FOR CONTROLLING A ROBOTIC ARM, COMPUTER PROGRAM AND NONVOLATILE DATA CARRIER

(71) Applicant: DELAVAL HOLDING AB, Tumba (SE)

(72) Inventor: Erik OSCARSSON, Tumba (SE)

(21) Appl. No.: 17/610,870

(22) PCT Filed: May 6, 2020
(86) PCT No.: PCT/SE2020/050460

§ 371 Date: Nov. 12, 2021

(30) Foreign Application Priority Data
May 14, 2019 (SE) 1950571-8

(51) Int. Cl. G06T 1/00; G06V 40/10; A01J 5/007

(52) U.S. Cl. CPC G06T 1/0014; A01J 5/007; G06V 40/10

(57) ABSTRACT

A camera registers three-dimensional image data representing a milking location for a milk-producing animal standing with its hind legs facing the camera, where the image data are processed to identify an udder of the animal, and subsequently a tail detection process is applied to the image data to identify a tail of the animal, where upon identification of the tail, the tail is excluded from being regarded as a teat when providing a decision basis for controlling a robotic arm that performs at least one action relating to a milk-producing animal. The tail detection process involves searching for an elongated object extending in a general direction being perpendicular to a floor surface of the rotating platform upon which the animal is standing and at a shorter distance from the camera than any surface element of the identified udder.

### TECHNICAL FIELD

The present invention relates generally to automatic milking of animals. In particular, the invention relates to a system for providing a decision basis for controlling a robotic arm to perform at least one action relating to a milk-producing animal, and a corresponding method. The invention also relates to a computer program implementing the method and a non-volatile data carrier storing the computer program.

### BACKGROUND

Today's automatic milking arrangements are highly complex installations. This is particularly true in scenarios where the milking procedure is handled in a fully automated manner by means of one or more milking robots that serve a number of milking stations. In such a case, the milking robot attaches teatcups and other tools, e.g. cleaning cups, to the animals without any human interaction. Of course, it is crucial that the movements of the milking robot's arm do not cause any injuries to the animals.

To this aim, the milking robot must be provided with a reliable decision basis. One component in this type of decision basis is information about the animal's tail.

U.S. Pat. No. 9,984,470 describes a system that includes a three-dimensional (3D) camera configured to capture a 3D image of a rearview of a dairy livestock in a stall. A processor is configured to obtain the 3D image, identify one or more regions within the 3D image comprising depth values greater than a depth value threshold, and apply the thigh gap detection rule set to the one or more regions to identify a thigh gap region. The processor is further configured to demarcate an access region within the thigh gap region and demarcate a tail detection region. The processor is further configured to partition the 3D image within the tail detection region to generate a plurality of image depth planes, examine each of the plurality of image depth planes, and determine position information for the tail of the dairy livestock in response to identifying the tail of the dairy livestock.

The above system may provide information to a controller for a robotic arm so that the tail can be avoided while positioning the robotic arm. However, there is room for improving the robotic arm control mechanisms.

### SUMMARY

The object of the present invention is therefore to offer an enhanced solution for providing a decision basis for controlling a robotic arm to perform at least one action relating to a milk-producing animal.

According to one aspect of the invention, the object is achieved by a system for providing a decision basis for controlling a robotic arm to perform at least one action relating to a milk-producing animal. The system contains a camera and a control unit. The camera is configured to register three-dimensional image data representing a milking location comprising a rotating platform upon which the animal is standing with its hind legs facing the camera. The control unit is configured to receive the image data from the camera, process the image data to identify an udder of the animal, and based thereon provide the decision basis.

After having identified the udder, the control unit is configured to apply a tail detection process to the image data to identify a tail of the animal. If the tail is identified, the control unit is further configured to exclude the tail from being regarded as a teat when providing the decision basis. The tail detection process comprises searching for an elongated object extending in a general direction being perpendicular to a floor surface of the rotating platform upon which floor surface said animal is standing.

The tail detection process further presumes that the elongated object is located at a shorter distance from the camera than any surface element of the identified udder.

This system is advantageous because it provides reliable information about the animal's tail, and thus reduces the risk of mishaps caused by the robotic arm when performing various actions relating to a milk-producing animal, for example attaching equipment to its teats. The proposed tail detection process provides comparatively trustworthy information, inter alia because the identified udder forms a basis for the search of the tail.

According to one embodiment of this aspect of the invention, the elongated object for which the tail detection process searches is presumed to be located at a horizontal distance measured from the camera along the floor surface, which horizontal distance is approximately the same along an entire extension of the elongated object. In other words, the tail is estimated to be pointing essentially straight down. Namely, in practice, this assumption has proven to give reliable output data.

Preferably, the elongated object for which the tail detection process searches is presumed to obstruct the camera's view of the udder, at least partially. This assumption is normally also true, especially if data from multiple images is considered, e.g. disregarding images representing occasions when the animal wags its tail to uncover the udder fully.

According to another embodiment of this aspect of the invention, after having identified an object in the image data, which object represents a tail candidate, the tail detection process further comprises following an extension of the tail candidate towards the floor surface in search of a tail tip candidate. If the tail tip candidate is found, the tail candidate is categorized as an identified tail. Hence, the decision basis can be given even stronger confidence.

According to yet another embodiment of this aspect of the invention, the control unit is configured to apply the tail detection process to a portion of the image data that represents a volume extending from a predefined position to a primary distance in a depth direction away from the camera. The predefined position is here located between the camera and the animal, and the primary distance is set based on a surface element of the identified udder, for example the part of the udder being closest to the camera. Thereby, the search space is limited to the most relevant volume in which the tail is expected to be found, and the search can be made more efficient.

Preferably, applying the tail detection process involves filtering out information in the image data, which information represents objects located farther away from the camera than a first threshold distance and closer to the camera than a second threshold distance. The first and second threshold distances are separated from one another by the primary distance. Consequently, the search space is further limited, and search can be made even more efficient.

According to still another embodiment of this aspect of the invention, the predefined position is located at the first threshold distance from the camera, for example at zero distance from the camera. Namely, for image quality reasons, the camera is often located so close to the expected animal position that the tail, or at least the tip thereof, reaches the camera.

According to another aspect of the invention, the object is achieved by a method of providing a decision basis for controlling a robotic arm to perform at least one action relating to a milk-producing animal. The method involves registering, via a camera, three-dimensional image data representing a milking location comprising a rotating platform upon which said animal is standing with its hind legs facing the camera. The method further involves processing the image data to identify an udder of said animal and based thereon provide the decision basis. After having detected the udder, the method comprises applying a tail detection process to the image data to identify a tail of the animal. If the tail is identified, the tail is excluded from being regarded as a teat when providing the decision basis. The tail detection process comprises searching for an elongated object extending in a general direction being perpendicular to a floor surface of the rotating platform upon which floor surface the animal is standing. The tail detection process further presumes that the elongated object is located at a shorter distance from the camera than any surface element of the identified udder. The advantages of this method, as well as the preferred embodiments thereof, are apparent from the discussion above with reference to the system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows a side view of a milk-producing animal and a system according to one embodiment the invention;

FIG. 2 illustrates a field of view of the animal in FIG. 1 as seen from the camera in the system;

FIG. 3 shows a block diagram over the system according to the invention; and

FIG. 4 illustrates, by means of a flow diagram, the general method according to the invention.

### DETAILED DESCRIPTION

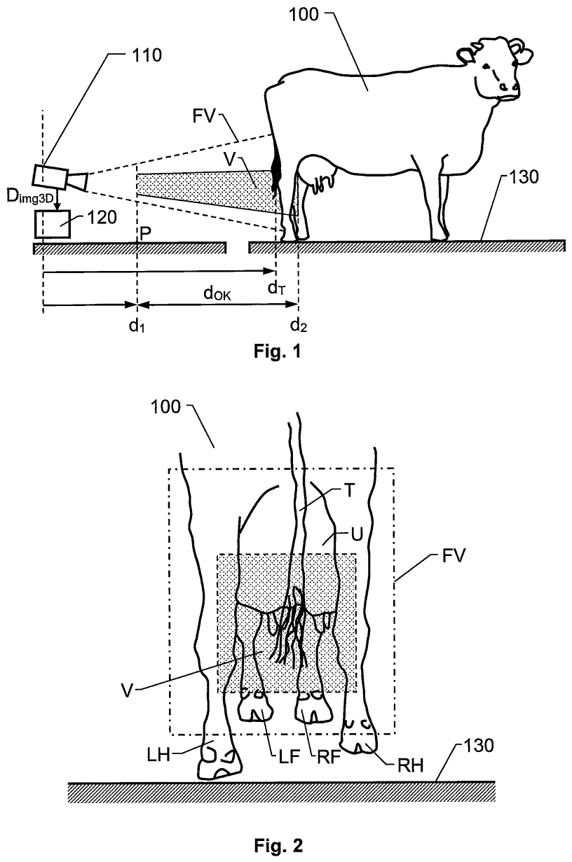

FIG. 1 shows a side view of a milk-producing animal 100 and a system according to one embodiment the invention.

The system is designed to provide a decision basis DB for controlling a robotic arm (not shown) to perform at least one action relating to a milk-producing animal 100, such as attaching teatcups, attaching cleaning cups, detaching teatcups and/or detaching cleaning cups to/from one or more teats of the animal's 100 udder and/or spraying the animal's 100 teats individually. In particular, the decision basis DB provided by the system contains data describing a position of the animal's 100 tail.

The system includes a camera 110 and a control unit 120. The camera 110 is configured to register 3D image data D_{img3D} representing a milking location. Preferably, the camera 110 is a time-of-flight (ToF) camera, i.e. range imaging camera system that resolves distance based on the known speed of light.

According to the invention, however, the camera 110 may be any alternative imaging system capable of determining the respective distances to the objects being imaged, for example a 2D camera emitting structured light or a combined light detection and ranging (LIDAR) camera system.

The milking location comprises a rotating platform 130 upon which the animal 100 is standing. FIG. 2 illustrates the camera's 110 field of view FV of the animal 100. The animal 100 stands with its hind legs LH and RH respectively facing the camera 110. The field of view FV is relatively wide. The camera 110 is preferably positioned at a distance 0.6 m to 1.0 m from to hind legs LH and RH. Thus, the animal's 100 tail is typically located around 0.4 m to 0.8 m away from the camera 110. Further, given the typical anatomy of a milk-producing animal 100, such as a cow, the location of the camera 110 and its field of view FV, the animal's 100 tail T normally obstructs parts of the animal's 100 udder U, as shown in FIG. 2.

At said distance the camera 110, and using typical optics, the camera's 110 view angle covers the full width of one milking stall plus at least 20% of the width of a neighboring stall. More preferably, the view angle covers at least the width of one and a half milking stall. Namely, thereby there is a high probability that a visual pattern, which repeats itself from one stall to another is visible in the same view. This, in turn, is advantageous when controlling the robotic arm to perform various actions relating to the milk-producing animals on the rotating platform 130 because knowledge of such repeating patterns increases the reliability with which the robotic arm can navigate on the rotating platform 130.

The control unit 120 is configured to receive the 3D image data D_{img3D} from the camera 110 and process the 3D image data D_{img3D} to identify the udder U. Based thereon, the control unit 120 is further configured to provide the decision basis DB. Specifically, according to the invention, after having identified the udder U, the control unit 120 is configured to apply a tail detection process to the image data D_{img3D} to identify the tail T. If the tail T is identified, the control unit 120 is configured to exclude the tail T from being regarded as a teat when providing the decision basis DB. Thereby, the risk of later mishaps due to the fact that a robotic arm controller mistakenly interprets the tail as a teat can be eliminated.

The tail detection process comprises searching for an elongated object that extends in a general direction being perpendicular to a floor surface of the rotating platform 130 upon which floor surface the animal 100 is standing. Here, the elongated object is presumed to be essentially perpendicular to the floor surface, at least as seen from a view angle of the camera 110. Moreover, the tail detection process presumes that the elongated object is located at a shorter distance from the camera 110 than any surface element of the identified udder U. This means that the udder U must be identified in the 3D image data D_{img3D} before the tail detection process can be applied.

Preferably, the elongated object, which is searched for in the tail detection process is presumed to be located at a horizontal distance d_{T} measured from the camera 110 along the floor surface, which horizontal distance d_{T} is approximately the same along an entire extension of said elongated object. In other words, the tail detection process preferably presumes that the elongated object representing a tail candidate is essentially perpendicular to the floor surface with respect to all spatial directions.

According to one embodiment of the invention, the tail detection process presumes that the elongated object being searched for at least partially obstructs the camera's 110 view of the udder U. This is in line with the above assumption about the animal's 100 anatomy in combination with the characteristics of the camera, e.g. its position, view angle and field of view FV; and it reduces the search space for suitable tail candidate. Thus, the efficiency of the search process is enhanced.

Moreover, after having identified an object in the 3D image data D_{img3D}, which object represents a tail candidate, the tail detection process preferably involves the steps of: (i) following an extension of the tail candidate towards the floor surface in search of a tail tip candidate, and if the tail tip candidate is found (ii) categorizing the tail candidate as an identified tail. Thereby, false positives in the form of other elongated object being perpendicular to the floor surface, e.g. stalling equipment in the form of posts, poles, railings or railing supports, can be avoided.

In order to limit the search space for tail candidates, it is further preferable if the control unit 120 is configured to apply the tail detection process only to a portion of the 3D image data D_{img3D} that represents a volume V extending from a predefined position P to a primary distance d_{OK} in a depth direction away from the camera 110. The predefined position P is located between the camera 110 and the animal 100. The primary distance d_{OK} is set based on a surface element of the identified udder U. The primary distance d_{OK} may start at the surface element of the identified udder U being located closest to the camera 110 and extend a particular distance towards the camera 110.

Applying the tail detection process exclusively to the volume V preferably involves filtering out information in the 3D image data D_{img3D}, which information represents objects located farther away from the camera 110 than a first threshold distance d₁ and closer to the camera 110 than a second threshold distance d₂. The first and second threshold distances d₁ and d₂ are separated from one another by the primary distance d_{OK}. According to one embodiment of the invention, the predefined position P is located at the first threshold distance d₁ from the camera 110.

If, for example, the camera 110 is located relatively close to the animal 100, say around 0.6-0.7 m away from the animal's 100 hind legs LH and RH, the primary distance d_{OK} preferably extends all the way up to the camera 110. Consequently, in such a case, the first threshold distance d₁ is almost zero, i.e. image data representing objects immediately in front of the camera's 110 front lens are considered in the tail detection process.

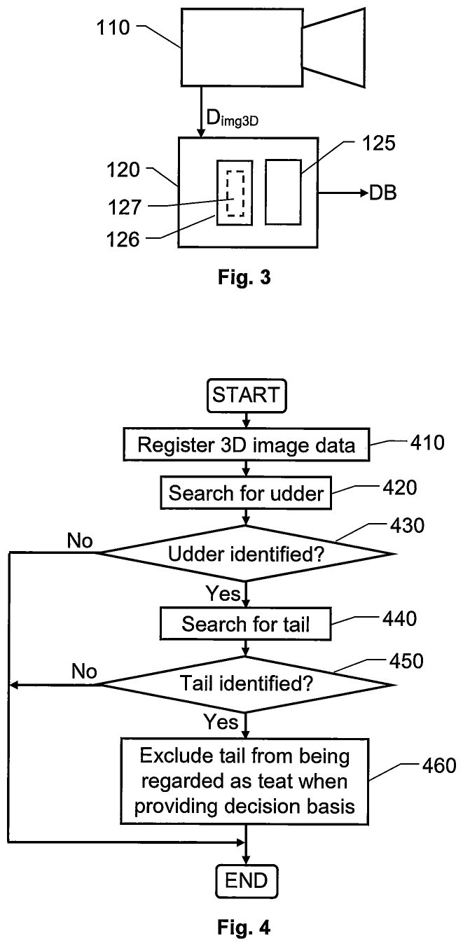

In FIG. 3, we see a block diagram the camera 130 and the control unit 120 included in the system according to the invention. It is generally advantageous if the control unit 120 and the camera 110 are configured to effect the above-described procedure in an automatic manner by executing a computer program 127. Therefore, the control unit 120 may include a memory unit 125, i.e. non-volatile data carrier, storing the computer program 127, which, in turn, contains software for making processing circuitry in the form of at least one processor 125 in the central control unit 120 execute the above-described actions when the computer program 127 is run on the at least one processor 125.

In order to sum up, and with reference to the flow diagram in FIG. 4, we will now describe the general method according to the invention of providing a decision basis for controlling a robotic arm to perform at least one action relating to a milk-producing animal.

In a first step 410, 3D image data are registered that represent a milking location, which, in turn, contains a rotating platform upon which a milk-producing animal is standing with its hind legs facing the camera.

Then, in a step 420, the 3D image data are processed to identify an udder of the animal.

If, in a subsequent step 430, the udder is found, the procedure continues to a step 440. Otherwise, the procedure ends.

In step 440, a tail detection process is applied to the image data in search for a tail of the animal. If the tail is identified, a step 460 follows; otherwise, the procedure ends.

The tail detection process involves searching for an elongated object that extends in a general direction being perpendicular to a floor surface of the rotating platform upon which floor surface said animal is standing. The tail detection process presumes that the elongated object is located at a shorter distance from the camera than any surface element of the identified udder.

In step 460, the tail is excluded from being regarded as a teat when providing a decision basis for controlling the robotic arm to perform the at least one action relating to a milk-producing animal.

All of the process steps, as well as any sub-sequence of steps, described with reference to FIG. 4 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1. A system for providing a decision basis (DB) for controlling a robotic arm to perform at least one action relating to a milk-producing animal (100), the system comprising:
a camera (110) configured to register three-dimensional image data (D_{img3D}) representing a milking location comprising a rotating platform (130) upon which said animal (100) is standing with its hind legs (LH, RH) facing the camera (110); and
a control unit (120) configured to provide the decision basis (DB) by performing functions of:
receive the image data (D_{img3D}) from the camera (110),
process the image data (D_{img3D}) to identify an udder (U) of said animal (100),
after having identified the udder (U), applying a tail detection process to the image data (D_{img3D}) to identify a tail (T) of said animal (100),
and on identification of the tail (T), excluding the tail (T) from being regarded as a teat when providing the decision basis (DB),
wherein the tail detection process comprises searching for an elongated object that i) extends in a direction perpendicular to a floor surface of the rotating platform (130) upon which said animal (100) is standing, and ii) is located at a shorter distance from the camera (110) than any surface element of the identified udder (U).

2. The system according to claim 1, wherein the elongated object being searched for in the tail detection process is presumed to be located at a horizontal distance (d_{T}) measured from the camera (110) along the floor surface, where said horizontal distance (d_{T}) is approximately the same along an entire extension of said elongated object.

3. The system according to claim 1, wherein the elongated object being searched for in the tail detection process is presumed to at least partially obstruct a view of the udder by the camera (110).

4. The system according to claim 1, wherein, after having identified the elongated object in the image data (D_{img3D}) as the tail candidate, the tail detection process proceeds with:
following an extension of the tail candidate towards the floor surface in search of a tail tip candidate, and categorizing the tail candidate as an identified tail when said tail tip candidate is found.

5. The system according to claim 1, wherein the control unit (120) is configured to apply the tail detection process to a portion of the image data (D_{img3D}) representing a volume (V) extending from a predefined position (P) to a primary distance (d_{OK}) in a depth direction away from the camera (110), the predefined position (P) being located between the camera (110) and said animal (100), and the primary distance (d_{OK}) being set based on a surface element of the identified udder (U).

6. The system according to claim 5, wherein the tail detection process further comprises filtering out information in the image data (D_{img3D}) that represents objects located farther away from the camera (110) than a first threshold distance (d₁) and closer to the camera (110) than a second threshold distance (d₂), the first and second threshold distances (d₁, d₂) being separated from one another by the primary distance (d_{OK}).

7. The system according to claim 6, wherein the predefined position (P) is located at the first threshold distance (d₁) from the camera (110).

8. The system according to claim 7, wherein the first threshold distance (d₁) is zero.

9. A method of providing a decision basis (DB) for controlling a robotic arm to perform at least one action relating to a milk-producing animal (100), the method comprising:
registering, via a camera (110), three-dimensional image data (D_{img3D}) representing a milking location comprising a rotating platform (130) upon which said animal (100) is standing with its hind legs (LH, RH) facing the camera (110);
processing the image data (D_{img3D}) to identify an udder (U) of said animal (100) and based thereon provide the decision basis (DB);
after having identified the udder (U), applying a tail detection process to the image data (D_{img3D}) to identify a tail (T) of said animal (100); and
on identification of the tail (T), excluding the tail (T) from being regarded as a teat when providing the decision basis (DB),
wherein the tail detection process comprises:
searching for an elongated object that i) extends in a direction perpendicular to a floor surface of the rotating platform (130) upon which said animal (100) is standing, and ii) is located at a shorter distance from the camera (110) than any surface element of the identified udder (U).

10. The method according to claim 9, wherein the elongated object being searched for in the tail detection process is presumed to be located at a horizontal distance (d_{T}) measured from the camera (110) along the floor surface, where said which horizontal distance (d_{T}) is approximately the same along an entire extension of said elongated object.

11. The method according to claim 9, wherein the elongated object being searched for in the tail detection process is presumed to at least partially obstruct a view of the udder by the camera (110).

12. The method according to claim 9, wherein, after having identified an object in the image data (D_{img3D}) as the tail candidate, the tail detection process proceeds with:
following an extension of the tail candidate towards the floor surface in search of a tail tip candidate, and categorizing the tail candidate as an identified tail when said tail tip candidate is found.

13. The method according to claim 9, wherein the tail detection process is applied to a portion of the image data (D_{img3D}) representing a volume (V) extending from a predefined position (P) to a primary distance (d_{OK}) in a depth direction away from the camera (110), the predefined position (P) being located between the camera (110) and said animal (100), and the primary distance (d_{OK}) being set based on a surface element of the identified udder (U).

14. The method according to claim 13, wherein applying the tail detection process further comprises filtering out information in the image data (D_{img3D}) that represents objects located farther away from the camera (110) than a first threshold distance (d₁) and closer to the camera (110) than a second threshold distance (d₂), the first and second threshold distances (d₁, d₂) being separated from one another by the primary distance (d_{OK}).

15. The method according to claim 14, wherein the predefined position (P) is located at the first threshold distance (d₁) from the camera (110).

16. The method according to claim 15, wherein the first threshold distance (d₁) is zero.

17. A non-transitory computer-readable data recording medium having recorded thereon a computer program (127) comprising software that, upon execution by the processing unit (125), causes the processing unit to execute the method according claim 9.

18. (canceled)
